(19) United States
(12) Patent Application Publication
(10) Pub. No.: US 2017/0190296 A1
(43) Pub. Date: Jul. 6, 2017

(54) ARTICLE RETAINER FOR A SEAT CUSHION IN A MOTOR VEHICLE

(71) Applicant: FORD GLOBAL TECHNOLOGIES, LLC, Dearborn, MI (US)

(72) Inventor: Alfredo Ivan Trujillo Rolon, Benito Juarez (MX)

(21) Appl. No.: 14/989,337

(22) Filed: Jan. 6, 2016

(51) Int. Cl. B60R 7/04; B60N 2/44

(52) U.S. Cl. CPC B60R 7/043; B60N 2/44; B60N 2/2887

(57) ABSTRACT

An article retainer is provided for a seat cushion in a motor vehicle. That article retainer includes a plurality of anchors fixed to the motor vehicle and an X-shaped strap assembly. That X-shaped strap assembly includes crossed straps and fasteners for securing the X-shaped strap assembly to the plurality of anchors. A related method is also provided.

### TECHNICAL FIELD

This document relates generally to the motor vehicle equipment field and, more particularly, to a new and improved article retainer for a seat cushion in a motor vehicle.

### BACKGROUND

It is common practice to place various articles on top of the seat cushions in a motor vehicle as the seat cushions are the most accessible place for such articles. Examples of the articles or objects placed on top of the seat cushions include books, umbrellas, boxes, shopping bags and packages, tablets, laptops, bottles and the like.

Unfortunately, unless these articles are positively held in position on the seat cushion forces generated during the driving of the vehicle may cause the articles to fall from the seat onto the floor where they are inaccessible and roll around.

In the past, in order to prevent this from occurring many individuals utilize a seatbelt to hold the articles in position. While a seat belt is particularly suited to restrain a passenger, it often will not function well to hold an article in position on a seat cushion.

Recognizing this shortcoming, elastic strap systems have been developed for maintaining an article on a seat cushion. See, for example, JP2013014280. The strap systems disclosed in that document include two spaced straps extending parallel to the X axis of the motor vehicle from the front end to the rear end of the seat cushion or a wide band of material also extending along the same axis.

While useful for their intended purpose, such strap systems which extend only along the X axis of the motor vehicle provide only a limited article holding force against the lateral forces generated during motor vehicle driving such as turning and cornering.

This document relates to a new and improved article retainer for a seat cushion incorporating an X-shaped strap assembly wherein the cross straps of the assembly extend at a bias to the X axis of the motor vehicle thereby providing improved article retention against lateral force generated during motor vehicle operation. Further, the crossed straps are more versatile and able to better retain different and more varied articles or objects than straps that extend exclusively in the fore-and-aft direction or along the X axis of the motor vehicle.

### SUMMARY

In accordance with the purposes and benefits described herein, an article retainer is provided for a seat cushion in a motor vehicle. That article retainer comprises a plurality of anchors fixed to the motor vehicle and an X-shaped strap assembly. That X-shaped strap assembly includes cross-straps and fasteners for securing that strap assembly to the plurality of anchors.

The fasteners may include a first fastener, a second fastener, a third fastener and a fourth fastener. The crossed straps may include a first crossed strap extending between the first fastener and the second fastener and a second crossed strap extending between the third fastener and the fourth fastener.

The first crossed strap may include a first elastic strap segment and a second elastic strap segment. The first elastic strap segment is parallel to and spaced from the second elastic strap segment.

The second crossed strap may include a third elastic strap segment and a fourth elastic strap segment. The third elastic strap segment is parallel to and spaced from the fourth elastic strap segment.

In one possible embodiment, the first elastic strap segment is connected to the third elastic strap segment at a first point of overlap and to the fourth elastic strap segment at a second point of overlap.

In one possible embodiment, the second elastic strap segment is connected to the third elastic strap segment at a third point of overlap and to the fourth elastic strap segment at a fourth point of overlap.

In one possible embodiment, the fasteners are hooks. In another possible embodiment the fasteners are buckles.

In some embodiments, the plurality of anchors includes a first pair of anchors at a rear end of the seat cushion and a second pair of anchors at a front end of the seat cushion. In at least one possible embodiment, the first pair of anchors are ISOFIX child seat anchors.

In accordance with an additional aspect, a method is provided for retaining an article on a seat cushion of a motor vehicle. That method comprises the steps of stretching an X-shaped strap assembly over the seat cushion and securing the article between the X-shaped strap assembly and the seat cushion. Further, the method may include the step of securing the X-shaped strap assembly at two anchor points at a rear end of the seat cushion and at two additional anchor points at a front end of the seat cushion.

In the following description, there are shown and described several preferred embodiments of the article retainer. As it should be realized, the article retainer is capable of other, different embodiments and its several details are capable of modification in various, obvious aspects all without departing from the article retainer as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the article retainer and together with the description serve to explain certain principles thereof. In the drawing figures:

FIG. 1 is a schematic top plane view of the article retainer including the plurality of anchors that are fixed to the motor vehicle and the X-shaped strap assembly with crossed straps and fasteners for securing the X-shaped strap assembly to the plurality of anchors.

FIG. 2 is a detailed perspective illustrating the article retainer securing a notebook and a tablet to the top of the seat cushion.

Reference will now be made in detail to the present preferred embodiments of the article retainer, examples of which are illustrated in the accompanying drawing figures.

### DETAILED DESCRIPTION

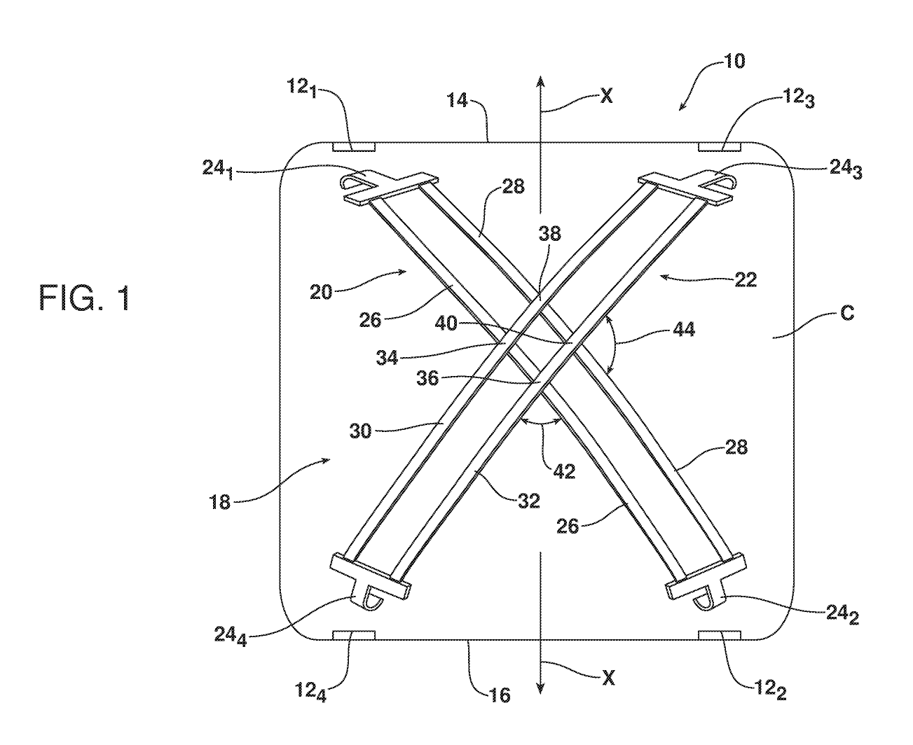

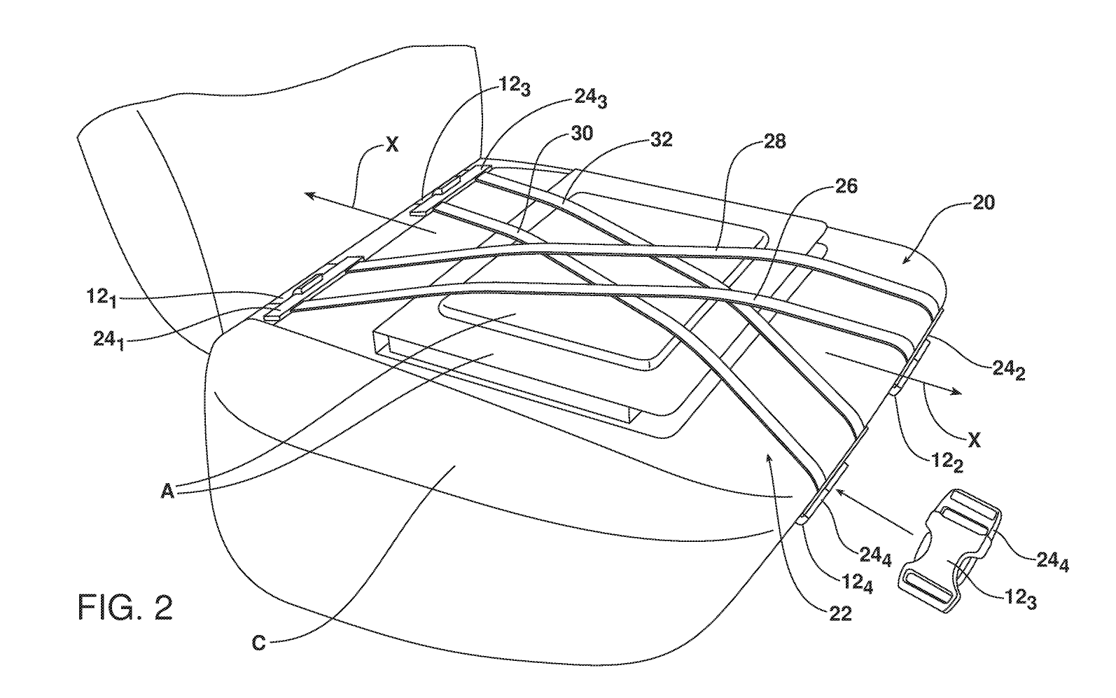

Reference is now made to FIGS. 1 and 2 illustrating the article retainer 10 for securing article A on a seat cushion C in a motor vehicle. As best illustrated in FIG. 1, the article retainer 10 includes a plurality of anchors 12₁-12₂ that are fixed to the motor vehicle. As illustrated in FIG. 2, the plurality of anchors 12₁-12₂ may include a first pair of anchors 12₁-12₃ at a rear end 14 of the seat cushion C and a second pair of anchors 12₄-12₂ at a second or front end 16 of the seat cushion. In some embodiments the first pair of anchors 12₁-12₃ may comprise ISOFIX child seat anchors.

As best illustrated in FIG. 1, the article retainer 10 also includes an X-shaped strap assembly generally designated by reference numeral 18. The X-shaped strap assembly 18 includes crossed straps 20, 22, and fasteners 24₁-24₂ for securing the X-shaped strap assembly to the plurality of anchors 12₁-12₂. Those fasteners may comprise hooks as illustrated in FIG. 1, buckles or clips as illustrated in FIG. 2, carabiners or any other appropriate structure for securing the X-shaped strap assembly 18 to the various anchors 12₁-12₂.

In the illustrated embodiment, the first crossed strap 20 extends between the first fastener 24₁ and the second fastener 24₃. The second crossed strap 22 extends between the third fastener 24₄ and a fourth fastener 24₂.

As further illustrated in FIG. 1, the first crossed strap 20 includes a first elastic strap segment 26 and a second elastic strap segment 28. The first elastic strap segment 26 is parallel to and spaced from the second elastic strap segment 28.

The second crossed strap 22 includes a third elastic strap segment 30 and a fourth elastic strap segment 32. The third elastic strap segment 30 is parallel to and spaced from the fourth elastic strap segment 32.

The elastic strap segment 26 is connected to the third elastic strap segment 30 at a first point of overlap 34 and to the fourth elastic strap segment 32 at a second point of overlap 36.

The second elastic strap segment 28 is connected to the third elastic strap segment 30 at a third point of overlap 38 and to the fourth elastic strap segment 32 at a fourth point of overlap 40. In one possible embodiment, a first and second elastic strap segments 26, 28 are connected to the third and fourth elastic strap segments 30, 32 by stitching. In another possible embodiment, they are connected together by an appropriate adhesive.

Reference is now made to FIG. 2 illustrating how the article retainer 10 is utilized and secured. Various articles A (e.g. a notebook and/or tablet) are carried on the top of the seat cushion C. As illustrated, the first crossed strap 20, comprising the elastic strap segments 26, 28, is secured by the fastener 24₁ to the first anchor 12₁ and by the fastener 24₃ to the fourth anchor 12₂. The second crossed strap 22, comprising the elastic strap segments 30, 32, is secured by the fastener 24₄ to the second anchor 12₃ and by the fourth fastener 24₂ to the third anchor 12₄. This serves to stretch the X-shaped strap assembly 18 across the top of the seat cushion C with the first and second crossed straps 20, 22 running at a bias to the X-axis X of the motor vehicle extending in a four aft direction. More specifically, in the illustrated embodiment, the first and second crossed straps 20, 22 define opposed acute included angles 42 opening towards the front and rear of the seat cushion C and opposed obtuse angles 44 opening towards the sides of the seat cushion.

Once the X-shaped strap assembly 18 of the article retainer 10 has been secured to the anchors 12₁-12₂ so that the crossed straps 20, 22 are stretched across the top of the seat cushion C, the straps may be stretched farther and lifted to place the articles A between the straps 20, 22 and the top of the seat cushion C. When released, the elastic memory of the material from which the elastic strap segments 26, 28, 30 and 32 are made causes the strap segments to squeeze and positively hold the articles A in position. Advantageously, since the first and second crossed straps 20, 22 and, therefore, the crossed elastic strap segments 26, 28, 30 and 32 extend at a bias or angle to the X axis of the motor vehicle, the article retainer 10 functions to better secure the articles A in position against the lateral forces to which they are subject during operation of the motor vehicle such as, for example, during hard cornering. Further, it should be appreciated that the parallel strap segments 26, 28, 30 and 32 of the two crossed straps 20, 22 are able to conform to and better grip irregularly shaped articles A.

Consistent with the above description, a method is also provided for retaining an article A on a seat cushion C of a motor vehicle. As described above that method includes stretching the X-shaped strap assembly 18 over the seat cushion C and securing the article A between the X-shaped strap assembly and the seat cushion. Further the method includes securing the X-shaped strap assembly 18 at two anchor points 12₁, 12₃ at a rear end 14 of the seat cushion C and at two additional anchor points 12₄, 12₂ at a front end 16 of the seat cushion.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. An article retainer for a seat cushion in a motor vehicle, comprising:
a plurality of anchors fixed to said motor vehicle, wherein said plurality of anchors includes a first pair of anchors at a rear end of said seat cushion and a second pair of anchors at a front end of said seat cushion; and
an X-shaped strap assembly including crossed straps and fasteners, said fasteners securing said X-shaped strap assembly to said plurality of anchors.

2. (canceled)

3. The article retainer of claim 1, wherein said first pair of anchors are ISOFIX child seat anchors.

4. The article retainer of claim 1, wherein said crossed straps are connected together at a point of overlap.

5. The article retainer of claim 1, wherein said fasteners include a first fastener, a second fastener, a third fastener and a fourth fastener.

6. The article retainer of claim 5, wherein said crossed straps include a first crossed strap extending between said first fastener and said second fastener.

7. The article retainer of claim 6, wherein said crossed straps include a second crossed strap extending between said third fastener and said fourth fastener.

8. The article retainer of claim 7, wherein said first crossed strap includes a first elastic strap segment and a second elastic strap segment.

9. The article retainer of claim 8, wherein said first elastic strap segment is parallel to and spaced from said second elastic strap segment.

10. The article retainer of claim 9, wherein said second crossed strap includes a third elastic strap segment and a fourth elastic strap segment.

11. The article retainer of claim 10, wherein said third elastic strap segment is parallel to and spaced from said fourth elastic strap segment.

12. The article retainer of claim 11, wherein said first elastic strap segment is connected to said third elastic strap segment at a first point of overlap and to said fourth elastic strap segment at a second point of overlap.

13. The article retainer of claim 12, wherein said second elastic strap segment is connected to said third elastic strap segment at a third point of overlap and to said fourth elastic strap segment at a fourth point of overlap.

14. The article retainer of claim 13, wherein said fasteners are hooks.

15. The article retainer of claim 14, wherein said fasteners are buckles.

16. The article retainer of claim 15, wherein said plurality of anchors includes a first pair of anchors at a rear end of said seat cushion and a second pair of anchors at a front end of said seat cushion.

17. The article retainer of claim 16, wherein said first pair of anchors are ISOFIX child seat anchors.

18. A method of retaining an article on a seat cushion of a motor vehicle, comprising:
stretching an X-shaped strap assembly over said seat cushion;
securing said X-shaped strap assembly at two anchor points at a rear end of said seat cushion and at two additional anchor points at a front end of said seat cushion; and
securing said article between said X-shaped strap assembly and said seat cushion.

19. (canceled)
